(19) United States
(12) Patent Application Publication
(10) Pub. No.: US 2019/0077328 A1
(43) Pub. Date: Mar. 14, 2019

(54) TRUCK RACK APPARATUS

(71) Applicant: Joseph Mickley, Eldersburg, MD (US)

(72) Inventor: Joseph Mickley, Eldersburg, MD (US)

(21) Appl. No.: 16/129,738

(22) Filed: Sep. 12, 2018

Related U.S. Application Data
(60) Provisional application No. 62/557,749, filed on Sep. 13, 2017.

(51) Int. Cl. B60R 9/048; B60P 3/40; B60R 9/058

(52) U.S. Cl. CPC B60R 9/0485; B60P 7/0823; B60R 9/058; B60P 3/40

(57) ABSTRACT

A truck rack apparatus is a two part, easily removable, truck rack for carrying elongated objects such as ladders, lumber, or pipe. A non-skid, padded, roof portion with elongated slots and the ends for tie-down straps is placed on the top of the cab of the truck and secured with an attachment strap that is attached to both ends of the roof portion and passes through the inside around the interior of the roof while the doors are open. The second part is a collapsible framework that sets in the interior of the bed of the truck and is secured with retaining straps to the sides of the truck bed.

### CROSS-REFERENCE TO RELATED APPLICATION

The present application is related to and claims priority from prior provisional application Ser. No. 62/557,749, filed Sep. 13, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of carry racks for vehicles and more specifically relates to a truck rack apparatus.

### 2. Description of the Related Art

The pickup truck has been a very popular vehicle not only for the average person because of its versatility in hauling large amounts of cargo and just for transportation, but it is especially very convenient in commercial use for the same reason. Most often when used commercially, there are accessories added that enhance its usage for the particular type of business it is used in. The most common of these accessories are the addition of tool boxes, which are quite often incorporated into the design of the bed portion of the body, and the addition of a rack for carrying long materials and tools such as pipe, lumber, sheeting, ladders, and just about anything that would normally be too long for the vehicle to haul without the rack. The extensive use of racks on pickups has also led to a plethora of various designs for racks to suit various needs, or to compliment a particular model and size of truck.

Truck racks are not only popular for commercial usage; they are very commonly used for private use as well. The designs vary considerably just as they do in commercial use but the one thing they nearly all have in common is that they are nearly always expensive to purchase. Very often the rack must be custom made for the particular size of truck it is used on. A large drawback is that when a rack is attached to a pickup, it is not easily removed and the rack usually changes the look of the truck from what may be a classier transportation vehicle to that of a work or contractor type appearance. Sometimes, the purpose of the rack is for nothing more than carrying a ladder so the installation of a standard truck rack is considerable over-kill, and so many people that would occasionally use them choose not to. A rack that is able to be carried without taking up space in case it is needed, inexpensive to purchase, and one that is easily removed when not in use is needed.

Various attempts have been made to solve the above-mentioned problems such as those found in U.S. Publication No. 2003/0201656 to Betty Ferguson; U.S. Pat. No. 5,037,152 to Jeffrey L. Hendricks; and U.S. Pat. No. 6,752,301 to Thomas A. Drolet. This art is representative of carry racks for vehicles. None of the above inventions and patents, taken either singly or in combination, is seen to describe the invention as claimed.

Ideally, carry racks for vehicles should be easily removable and collapsible, and yet, would operate reliably and be manufactured at a modest expense. Thus, a need exists for a reliable truck rack apparatus to avoid the above-mentioned problems.

### BRIEF SUMMARY OF THE INVENTION

In view of the foregoing disadvantages inherent in the known carry racks for vehicles art, the present invention provides a novel truck rack apparatus. The general purpose of the present invention, which will be described subsequently in greater detail, is to provide an easily removable and collapsible truck rack.

A truck rack apparatus may comprise a collapsible framework that includes a plurality of frame members that are releasably interconnected to form a rectangular shape adapted to fit and be removably placed within a bed of a truck to hold items in position with respect to the bed of the truck. A lockdown member having an elongated body portion is adapted to be removably secured to the roof of the truck and at least one attachment member is connected to the elongated body portion and is adapted to removably connect the lockdown member to the roof of the truck.

At least one adjustable strap member is connected to the elongated body portion and is adapted to removably hold down items placed between the framework and the lockdown member. When in use an item to be carried by the truck is placed between and onto the collapsible framework and the lockdown member and then secured to the lockdown member via the adjustable strap member to thereby be securely carried and transported via the truck.

The plurality of frame members includes two spaced elongated floor members adapted to extend along a length of the bed of the truck and provide stability to the collapsible framework. The two spaced elongated floor members each include a removable fastener on a distal end portion thereof adapted to releasably connect with the bed of the truck. The plurality of frame members also includes two spaced elongated vertical frame members and at least one horizontal frame member connected therebetween. The elongated floor members each include a series of spaced apertures therethrough along their lengths and the two spaced elongated vertical frame members are pivotally connected respectively to the two spaced elongated floor members.

The frame members may further include two spaced vertical frame member supports pivotally connected at respective proximal ends to respective spaced elongated vertical frame members that are releasably connected at respective distal ends to a chosen one of the spaced apertures of the two spaced elongated floor members such that the angle between the two spaced elongated vertical frame members and the two spaced elongated floor members can be adjusted. Each of the two spaced vertical frame member supports are releasably connected at the respective distal ends to one of the chosen spaced apertures on each of the two spaced elongated floor members via releasable pin members. Each of the two spaced elongated floor members are formed from two telescopingly interconnected floor member portions and can be adjustable in length and adapted to fit within differently sized beds of different sized trucks.

At least one attachment member of the lockdown member is formed as an adjustable elongated strap adapted to pass through windows of the truck to thereby and removably connect the lockdown member to the roof of the truck. The elongated body portion includes a loop at each respective opposite end for tie-down straps and the adjustable strap member is adapted to pass through each loop when removably holding down items placed between the framework and the lockdown member.

When in use, the rectangular shape of the collapsible framework has dimensions including 6 feet in length and 4 feet in width. When in use, the rectangular shape of the collapsible framework may have dimensions of between 6 feet and 8 feet in length via the two telescopingly interconnected floor member portions, and 4 feet in width. The plurality of frame members is formed from aluminum tubing. An exterior portion of the elongated body portion of the lockdown member is formed from foam rubber.

The present invention holds significant improvements and serves as a truck rack apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a truck rack apparatus, constructed and operative according to the teachings of the present invention.

FIG. 1 shows a perspective view illustrating an in-use condition of a truck rack apparatus according to an embodiment of the present invention.

FIG. 2 is a perspective view illustrating a truck rack apparatus according to an embodiment of the present invention of FIG. 1.

FIG. 3 is a side view illustrating truck rack apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to carry racks for vehicles and more particularly to a truck rack apparatus as used to improve the versatility by being easily removable and collapsible.

Generally speaking, a truck rack apparatus is a two part, easily removable, truck rack for carrying elongated objects such as ladders, lumber, or pipe. A non-skid, padded, roof portion with elongated slots and the ends for tie-down straps is placed on the top of the cab of the truck and secured with an attachment strap that is attached to both ends of the roof portion and passes through the inside around the interior of the roof while the doors are open. The second part is a collapsible framework that sets in the interior of the bed of the truck and is secured with retaining straps to the sides of the truck bed.

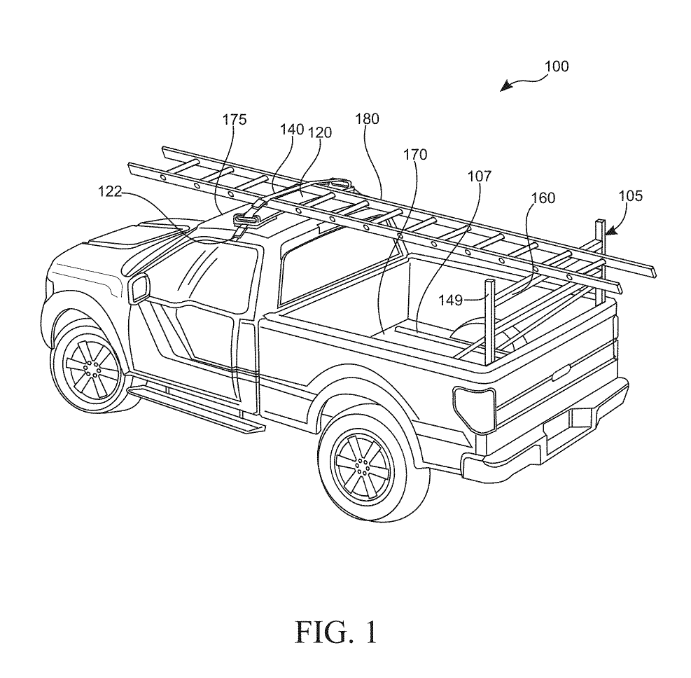

Referring to the drawings by numerals of reference there is shown in FIG. 1, a perspective view illustrating an in-use condition of truck rack apparatus 100 according to an embodiment of the present invention.

Truck rack apparatus 100 may comprise collapsible framework 105 that includes a plurality of frame members 106 that are releasably interconnected to form a rectangular shape adapted to fit and be removably placed within truck bed 170 to hold items in position with respect to truck bed 170. Lockdown member 120 having an elongated body portion 121 is adapted to be removably secured to truck roof 175 and at least one attachment member 123 is connected to elongated body portion 121 and is adapted to removably connect lockdown member 120 to truck roof 175.

At least one adjustable strap member 140 is connected to elongated body portion 121 and is adapted to removably hold down items placed between collapsible framework 105 and lockdown member 120. When in use an item to be carried by the truck is placed between and onto collapsible framework 105 and lockdown member 120 and then secured to lockdown member 120 via adjustable strap member 140 to thereby be securely carried and transported via the truck.

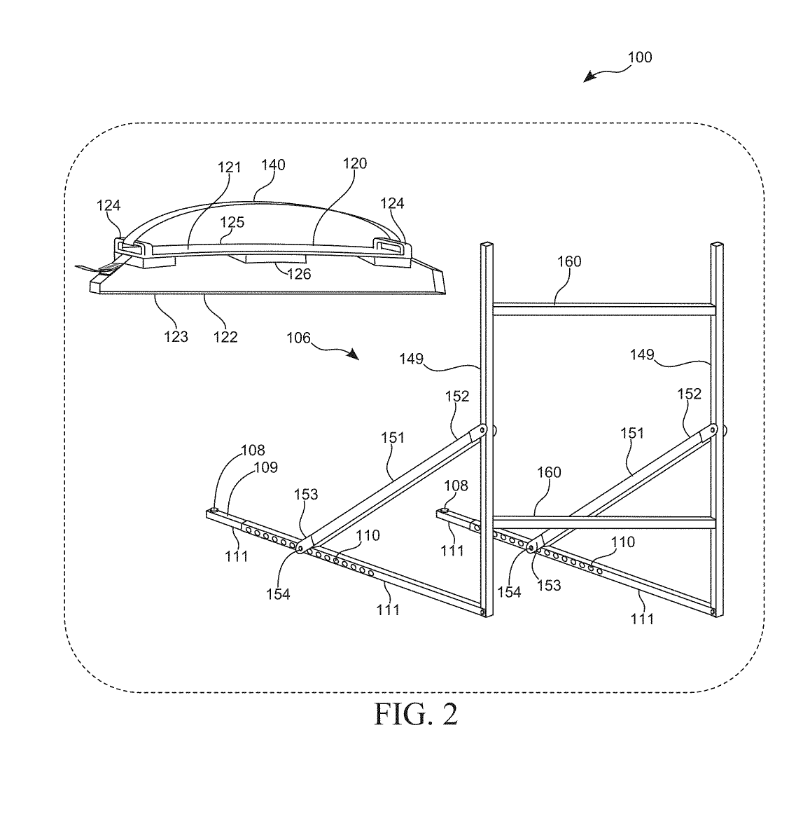

Referring now to FIG. 2, is a perspective view illustrating truck rack apparatus 100 according to an embodiment of the present invention of FIG. 1.

The plurality of frame members 106 includes two spaced elongated floor members 107 adapted to extend along a length of truck bed 170 and provide stability to collapsible framework 105. The two spaced elongated floor members 107 each include removable fastener 108 on distal end portion 109 thereof adapted to releasably connect with truck bed 170. The plurality of frame members 106 also includes two spaced elongated vertical frame members 149 and at least one horizontal frame member 160 connected therebetween. The elongated floor members 107 each include a series of spaced apertures 110 therethrough along their lengths and the two spaced elongated vertical frame members 149 are pivotally connected respectively to the two spaced elongated floor members 107.

Frame members 106 may further include two spaced vertical frame member supports 151 pivotally connected at respective proximal end 152 to respective spaced elongated vertical frame members 149 that are releasably connected at respective distal ends 153 to a chosen one of spaced apertures 110 of the two spaced elongated floor members 107 such that the angle between the two spaced elongated vertical frame member 149 and the two spaced elongated floor members 107 can be adjusted. Each of the two spaced vertical frame member supports 151 are releasably connected at the respective distal ends 153 to one of the chosen spaced apertures 110 on each of the two spaced elongated floor members 107 via releasable pin members 154. Each of the two spaced elongated floor members 107 are formed from two telescopingly interconnected floor member portions 111 and can be adjustable in length and adapted to fit within differently sized beds of different sized trucks.

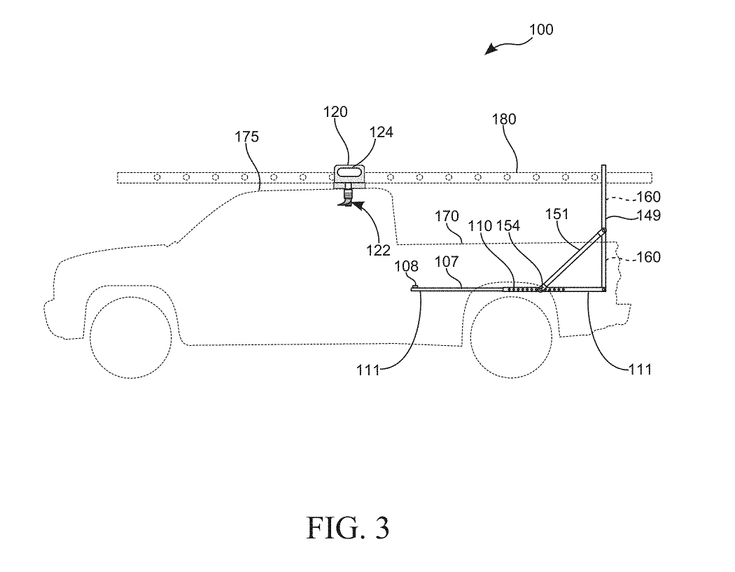

Referring now to FIG. 3, is a side view illustrating truck rack apparatus 100 according to an embodiment of the present invention of FIG. 1.

At least one attachment member 123 of lockdown member 120 is formed as an adjustable elongated strap 122 adapted to pass through windows of the truck to removably connect lockdown member 120 to truck roof 175. Elongated body portion 121 includes loop 124 at each respective opposite end for adjustable strap member 140 and adjustable strap member 140 is adapted to pass through each loop 124 when removably holding down items placed between collapsible framework 105 and lockdown member 120.

When in use, the rectangular shape of collapsible framework 105 has dimensions including 6 feet in length and 4 feet in width. When in use, the rectangular shape of collapsible framework 105 may have dimensions of between 6 feet and 8 feet in length via the two telescopingly interconnected floor member portions 111, and 4 feet in width. The plurality of frame members 106 is formed from aluminum tubing. Exterior portion 125 of elongated body portion 121 of lockdown member 120 is formed from foam rubber 126.

The steps that may be taken to install and use truck rack apparatus 100 may include: placing lockdown member 120 on truck roof 175 and securing with adjustable elongated strap 122 or attachment member 123, placing collapsible framework 105 in truck bed 170 orienting vertical frame members 149 closest to the back of truck bed 170 and raising vertical frame members 149 to a desired vertical or near vertical position, aligning a hole in vertical frame member supports 151 with spaced apertures 110 of elongated floor members 107 and securing with releasable pin members 154, placing ladder or other elongated cargo between and onto collapsible framework 105 and lockdown member 120, and securing load with adjustable strap member 140.

Truck rack apparatus 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., kit contents or arrangements such as, for example, including more or less components, customized parts, different color combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A truck rack apparatus comprising:
a collapsible framework including:
a plurality of frame members;
wherein said plurality of frame members are releasably interconnected to form a rectangular shape adapted to fit within and be removably placed within a bed of a truck; and
wherein said plurality of frame members are adapted to hold items in position with respect to said bed of said truck; and
a lockdown member including:
an elongated body portion;
wherein said elongated body portion is adapted to be removably secured to a roof of said truck;
at least one attachment member;
wherein said at least one attachment member is connected to said elongated body portion and is adapted to removably connect said lockdown member to said roof of said truck; and
at least one adjustable strap member;
wherein said at least one adjustable strap member is connected to said elongated body portion and is adapted to removably hold down items placed between said framework and said lockdown member;
wherein when in use an item to be carried by said truck is placed between said collapsible framework and said lockdown member, and then secured to said lockdown member via said at least one adjustable strap member, to thereby be securely carried and transported via said truck.

2. The truck rack apparatus of claim 1, wherein said plurality of frame members includes two spaced elongated floor members adapted to extend along a length of said bed of said truck and provide stability to said collapsible framework.

3. The truck rack apparatus of claim 2, wherein said two spaced elongated floor members each includes a removable fastener on a distal end portion thereof adapted to releasably connect with said bed of said truck.

4. The truck rack apparatus of claim 2, wherein said plurality of frame members includes two spaced elongated vertical frame members and at least one horizontal frame member connected therebetween; wherein said two spaced elongated floor members each include a series of spaced apertures therethrough along a respective length thereof; wherein said two spaced elongated vertical frame members are pivotally connected respectively to said two spaced elongated floor members; and wherein said plurality of frame members further includes two spaced vertical frame member supports pivotally connected at respective proximal ends thereof to respective said two spaced elongated vertical frame members, and releasably connected at respective distal ends thereof to chosen said series of spaced apertures of said two spaced elongated floor members, such that the angle between said two spaced elongated vertical frame members and said two spaced elongated floor members can be adjusted.

5. The truck rack apparatus of claim 4, wherein each of said two spaced vertical frame member supports are releasably connected at said respective distal ends thereof to respective said chosen spaced aperture of said two spaced elongated floor members via releasable pin members.

6. The truck rack apparatus of claim 3, wherein each of said two spaced elongated floor members are formed from two telescopingly interconnected floor member portions, to thereby be adjustable in length and adapted to fit within differently sized beds of different sized trucks.

7. The truck rack apparatus of claim 1, wherein said at least one attachment member of said lockdown member is formed as an adjustable elongated strap adapted to pass through windows of said truck to thereby and removably connect said lockdown member to said roof of said truck.

8. The truck rack apparatus of claim 1, wherein said elongated body portion includes a loop at each respective opposite ends thereof; and wherein said at least one adjustable strap member is adapted to pass through each loop when removably holding down items placed between said framework and said lockdown member.

9. The truck rack apparatus of claim 1, wherein when in use said rectangular shape of said collapsible framework has dimensions including 6 feet in length and 4 feet in width.

10. The truck rack apparatus of claim 6, wherein when in use said rectangular shape of said collapsible framework has dimensions including between 6 feet and 8 feet in length via said two telescopingly interconnected floor member portions, and 4 feet in width.

11. The truck rack apparatus of claim 1, wherein said plurality of frame members are formed from aluminum tubing.

12. The truck rack apparatus of claim 1, wherein an exterior portion of said elongated body portion of said lockdown member is formed from foam rubber.
